(19) United States
(12) Patent Application Publication
(10) Pub. No.: US 2004/0132330 A1
(43) Pub. Date: Jul. 8, 2004

(54) Terminal strip for interconnecting lines

(76) Inventors: Pierre Bonvallat, Cluses (FR); Xavier Fasce, Marignier (FR)

Correspondence Address: 3M INNOVATIVE PROPERTIES COMPANY, P.O. BOX 33427, ST. PAUL, MN, 55133-3427, US

(21) Appl. No.: 10/472,031

(22) PCT Filed: Mar. 27, 2002
(86) PCT No.: PCT/US02/09177

(30) Foreign Application Priority Data
Mar. 29, 2001 (EP) 01420073.7

(51) Int. Cl. H01R 4/24

(52) U.S. Cl. 439/403

(57) ABSTRACT

A terminal strip for interconnecting electrical lines, especially telephone or computer lines, comprising a single row of mutually parallel first conducting elements (9) placed side by side, each having an insulation-displacement end intended to house a line wire, the insulation-displacement ends of the first conducting elements being oriented towards the upper longitudinal side (7), and a single row of second mutually parallel conducting elements (11) placed side by side, each having an insulation-displacement end intended to house a line wire, the insulation-displacement ends of the second conducting elements being oriented towards the lower longitudinal side (8). These two rows (9, 11) are in a same plane and are interconnected via respective interruption points which are offset with respect to said common plane.

The present invention relates to a terminal strip for interconnecting electrical lines, especially telephone or computer lines.

### BACKGROUND OF THE INVENTION

Documents U.S. Pat. No. 5,388,999, GB-2,310,962, AU-3,263,489 and EP-0,524,115 describe terminal strips.

In general, terminal strips are mounted on metal fastening rails which often form an earthed support frame. They are mounted in such a way that their lateral faces are in contact or are very close to one another.

However, the terminal strips of the prior art have a substantial thickness. This results in a decrease in the number of terminal strips that can be mounted on a given length of metal fastening rail. The main drawback of such existing terminal strips is that they are dimensioned in such a way that the capacity of a length of a fastening rail forming a support frame is limited.

Furthermore, these terminal strips comprise two rows of conducting elements, called “insulation-displacement contacts”, placed side by side, parallel to one another. They each have an insulation-displacement end configured to receive a line wire and they are aligned face-to-face in two rows in the body of the terminal strip. These insulation-displacement contacts are connected to the conductors of the wire or to jumpers. Because of the parallel rows, the input array and output array of the terminal strip are located on the same upper longitudinal side of the terminal strip. This creates a particularly dense connection and entanglement of wires, together with a packet of wires.

Yet another drawback of the terminal strips of the prior art is that in order to change the connections, access to a terminal strip located in the middle of other terminal strips, when such strips are placed along a metal fastening rail in a group and once the terminal strip has been connected, is difficult.

U.S. Pat. No. 4,618,204 discloses connection devices, in particular for telecommunication lines, comprising conductor elements arranged side by side parallel to each other, each split at one end in order to receive a line wire, the conductor elements being retained axially between the two assembled parts of an insulating casing and constituting two alignments, rows or arrays arranged in facing relationship in said casing. The split end parts of the plugs are arranged in the direction of the longitudinal side of one of the parts of the casing, on the side opposite the open assembly side of said part of the casing. The longitudinal side of the casing comprises, on the one hand, driving or guiding slots provided opposite the slots of the end parts, transversely with respect to said longitudinal side and opening out on the two side faces adjacent said longitudinal side and on the other hand, access slots, passing through the same longitudinal side of the casing, longitudinally between the two alignments of split end parts of conductor elements.

However, one drawback with this type of connection device remains its thickness due to the presence of the two rows of conducting elements. Another drawback is that means for stowing the connection wires is missing. Yet another drawback with the connection devices of the prior art is that the input array is not separated from the output array.

### SUMMARY OF THE INVENTION

According to the present invention, a terminal strip for interconnecting electrical lines, especially telephone or computer lines, is characterized in that it comprises

a) a single row of mutually parallel, first conducting elements placed side-by-side, each first conducting element having an insulation-displacement end configured to receive a line wire, that is oriented towards the upper longitudinal side of the terminal strip, and a single row of mutually parallel, second conducting elements placed side-by-side, each second conducting element having an insulation-displacement end configured to receive a line wire, that is oriented towards the lower longitudinal side of the terminal strip;

b) in that the insulation-displacement ends of the first and second conducting elements all lie within a same plane;

c) in that the first and second conducting elements are in two parts, and each first conducting element is separated from a second conducting element by a point of interruption; and

d) in that said point of interruption is offset with respect to the plane defined by the first and second conducting elements.

Preferably, the first conducting element comprises at least one moveable flexible tab which, when installed in the terminal strip, is positioned on and touches a fixed part of the second conducting element.

In the upper longitudinal side of the terminal strip, and adjacent to each first conducting element, access holes are preferably provided for the insertion of a conducting test plug or an insulating interrupt plug. The conducting plug or the insulating plug can be inserted through the access hole into the body of the terminal strip and adjacent to the point of interruption such that it can be slipped between the flexible tab and the fixed part.

The upper and lower longitudinal sides of the terminal strip preferably have a push-in slot for each insulation-displacement end. These slots extend transversely from the upper or lower longitudinal sides, respectively, and extend into the body of the terminal block along one of the lateral face.

In one particular embodiment, the terminal strip includes lead-in channels molded or formed in, or attached to one of the lateral faces of the terminal block. Preferably, the channels are located on the same lateral face of the terminal block as the push-in slots. Each of the channels curves away from one of the transverse sides towards at least one of the push-in slots, that is to say, towards at least one insulation-displacement contact. The terminal strip may also include a smooth lateral face on the opposite the lateral face having the push-in slots.

In order to allow it to be fastened to the support frame, the terminal strip preferably includes positioning and fastening means on each of the two transverse sides. These positioning and fastening means may be located on the two transverse sides and near the two upper and lower longitudinal sides. In order to allow the terminal strips to be fastened together, the terminal strip includes interlocking means, located on each of the two lateral faces such that the interlocking means on one face fits into the interlocking means on the other face.

In a particular embodiment, the terminal strip includes a drain collector near the upper longitudinal side. In order to identify a group of terminal strips mounted on the rail forming the support frame, the last terminal strip of a series of terminal strips positioned on the rail may include a first label holder which also serves to close off the last lead-in channels of the last terminal strip. In order to identify the terminal strips, these may include a second label holder located on their upper longitudinal side.

### BRIEF DESCRIPTION OF THE DRAWINGS

The invention will be thoroughly understood from the various advantages and various characteristics which will become apparent from the following description, the non-limiting embodiment, and with reference to the appended schematic drawings in which:

FIG. 1 shows a side view of an interconnection terminal strip;

FIG. 2 shows another side view of the interconnection terminal strip;

FIG. 3 shows a longitudinal top view of the interconnection terminal strip;

FIG. 4 shows a transverse view of the interconnection terminal strip;

FIG. 5 shows a side view of the interconnection terminal strip mounted on a support frame provided with a cable;

FIG. 6 shows a partial side view, with a cut-away in cross section, of part of the interconnection terminal strip;

FIG. 7A shows a cross section of the interconnection terminal strip on the line VII-VII in FIG. 2;

FIG. 7B shows the cross section of 7A with a test plug ready to be inserted;

FIG. 7C shows the cross section of 7A and 7B with the test plug fully inserted; and

FIG. 8 shows various transverse views with a cut-away of a rail forming a support frame provided with interconnection terminal strips.

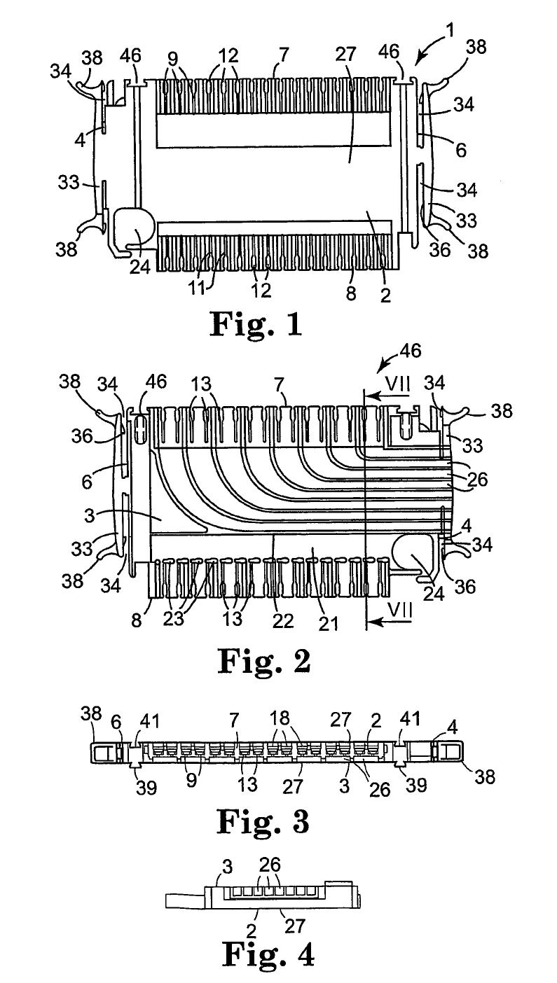

### DESCRIPTION OF THE PREFERRED EMBODIMENTS

A multicontact interconnection terminal strip 1 has two lateral faces 2, 3 of a overall rectangular shape, a left transverse side 4, a right transverse side 6, an upper longitudinal side 7 and a lower longitudinal side 8.

The upper longitudinal side 7 has a row of upper metal insulation-displacement contacts 9. The lower longitudinal side 8 has a row of lower metal insulation-displacement contacts 11. These insulation-displacement contacts 9, 11 lie within the same plane P. This plane P is parallel to the two lateral faces 2, 3. The upper and lower insulation-displacement contacts 9, 11 each include a slot 12 for the insertion of a line wire. These insertion slots 12 always face push-in slots 13 made in the body of the terminal strip. The push-in slots 13 are made in one of the lateral faces 3 of the terminal strip. The push-in slots 13 extend upwards in the case of those associated with the upper contacts 9 and downwards in the case of those associated with the lower contacts 11.

The upper contacts 9 are physically separate from the lower contacts 11. The upper contacts 9 each have a flexible tongue 14 located at their end on the opposite side from the insulation-displacement end. The lower contacts 11 each have a rigid or fixed part 16 located at their end on the opposite side from the insulation-displacement end. This flexible tongue 14 and this fixed part 16 will touch each other and thus form a point of contact and of interruption 17.

The rest position of the flexible tongue 14 of the upper insulation-displacement contacts 9 is offset from the plane P defined by the upper 9 and lower 11 contacts. The fixed part 16 of the lower contact 11 is also offset with respect to the plane P defined by these upper and lower contacts 9, 11. This means that the point of interruption is offset with respect to this same plane P.

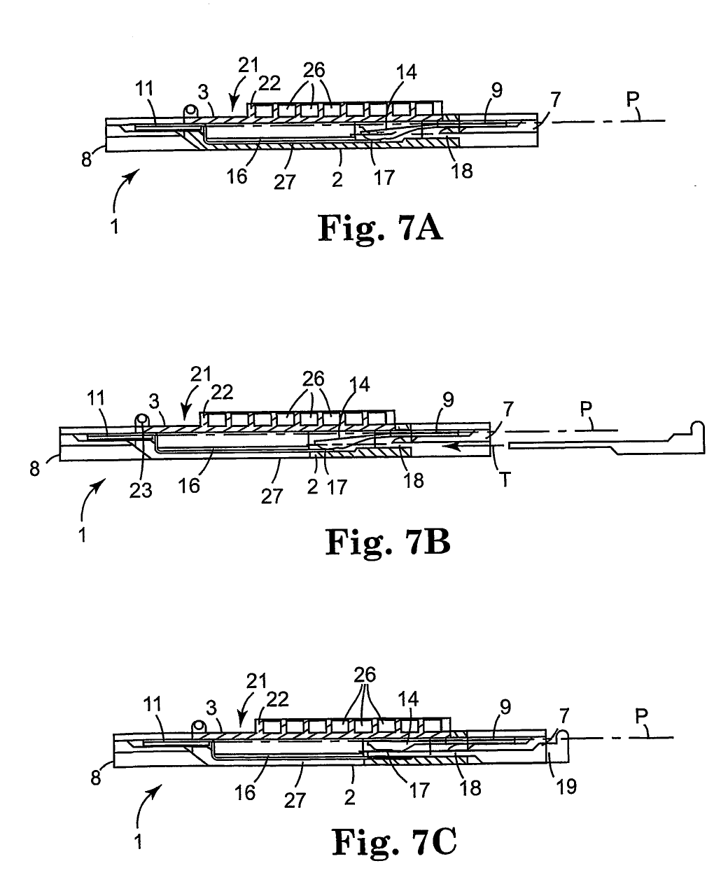

Provided, in the terminal strip 1, for each of the upper insulation-displacement contacts 9 is an upper hole 18 intended for the insertion of a plug 19. This plug (see more particularly FIGS. 7B and 7C) can be inserted into the terminal strip (in the direction of the arrow T) up to the point of interruption 17 between the flexible tongue 14 of the insulation-displacement contact 9 and the fixed part 16 of the lower insulation-displacement contact 11. FIG. 7A clearly shows the two possible positions of the flexible tongue 14, the position of the tongue shown along the plane P being that in which the flexible tongue 14 is forced to move away from its rest position when the plug 19 is inserted. The plug 19 is inserted by moving it parallel (along the arrow T) to the longitudinal axis of the upper and lower insulation-displacement contacts 9 and 11, and thus also parallel to the plane P.

Two types of test plug 19 can be used. Insulating test plugs can be used to make an interruption between the upper contact 9 and the lower contact 11. Conducting test plugs can be used to measure and test the state and quality of the conducting lines connected to the terminal strip.

In order to connect an input array, a longitudinal channel 21 is provided beneath the push-in slots 13, this channel being designed to lead in the line wires by an insertion of the same. The channel 21 is bounded in its upper part by a rib 22. In its lower part, the channel is bounded by a comb 23. If, as depicted in the drawings, there are 16 lower insulation-displacement contacts 11, then 16 wires will pass through a ring 24 and be “combed” by the 16 interstices lying between the tines defining the comb 23. By a better grip of the wire, this allows the mechanical strength and a better conductivity of the lower insulation-displacement contacts 11, and also the conditions of connecting to be improved. Each of the wires is connected right opposite each of the push-in slots 13.

In order to connect an output array, the same lateral face 3 includes a series of lead-in channels 26. Each of the lead-in channels 26 extend from the transverse side 4 as far as a push-in slot 13 for an upper insulation-displacement contact 9. If 16 upper insulation-displacement contacts 9 are provided (as depicted in the drawings), then 16 lead-in channels 26 will be located on the lateral face 8. Preferably, the lead-in channels 26 will form a substantially rounded bend to avoid sharp bend in the wires that will pass through the lead-in channels 26. The lead-in channels 26 permit real ordering of the connection wires, thus conserving space.

A completely flat plate 27 has been provided on the other lateral face 2. When the interconnection terminal strip is inserted on a rail forming a support frame 28, the plate 27 of one of the terminal strips closes off the lead-in channels 26 of the previous terminal strip, and so on until the end of the rail. At the end, in order to close off the open lead-in channels 26 of the last terminal strip, either a piece which also forms a label holder 29, or a simple plate, has been provided.

A cable with an insulating jacket and its line wires 30 is advantageously positioned at the bottom of the U-shaped rail forming the support frame 28.

In order to be able to fasten the interconnection terminal strip to the rail forming the support frame 28 having the shape of a U with two upwardly extending side arms 31, 32, two insertion and fastening means are provided on each side of the terminal strip. These means are in the form of a jamb 33 attached at its center to each of the transverse sides, namely the left side 4 and the right side 6. These two jambs 33 thus define four slots 34 into which the two side arms 31, 32 of the rail 28 may be inserted.

The jambs 33 include a catch 36 which projects inside the slot 34 and is intended to engage with openings 37 present in the side arms 31, 32 of the rail 28. Two of the slots 34 extend upwards along the transverse side of the terminal strip and open to the upper longitudinal side 7, whereas the other two slots 34 extend downwards along the transverse side of the terminal strip and open to the lower longitudinal side 8. The two jambs 33 lying on each side of the terminal strip also each include two gripping hooks 38 intended to move the jambs 33 apart on the transverse side in question, and to widen the slots 34, so as to allow the two side arms 31, 32 of the rail forming a support frame 28 to be inserted, and also extracted after having disengaged the catches 36.

The operator thus wires up the terminal strip by firstly mounting the terminal strip on the rail forming the support frame 28, presenting the lower longitudinal side 8 upwards and inserting the line wires into the lower insulation-displacement contacts 11. Next, the operator releases the terminal strip and turns it upside down in order to fit it again on the rail forming the support frame 28, so as to be able to insert the line wires into the upper insulation-displacement contacts 9, the upper longitudinal side 7 then being oriented upwards.

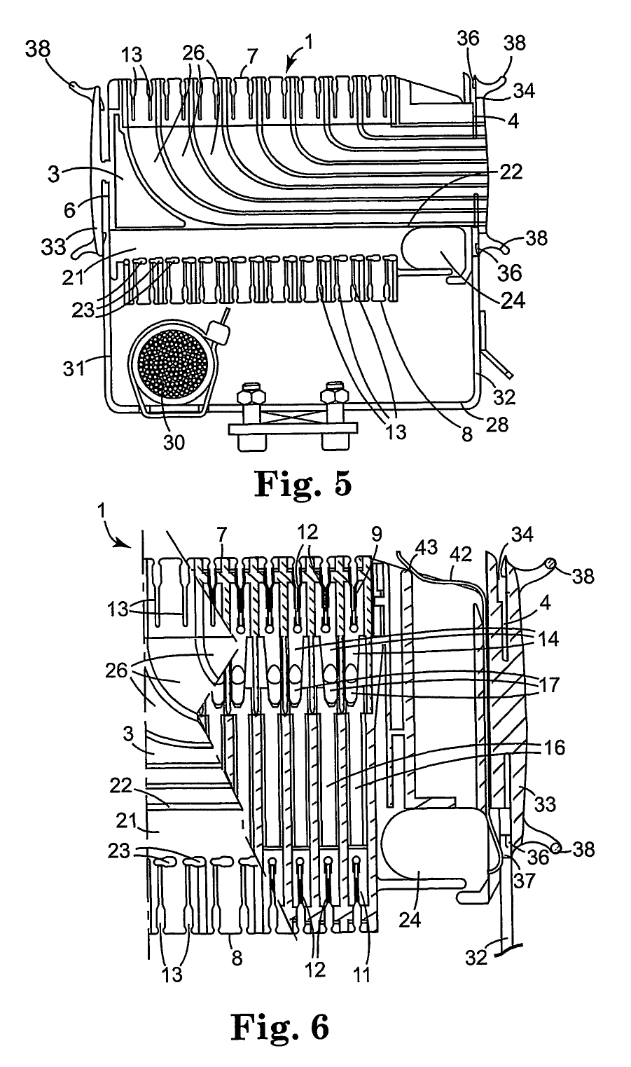

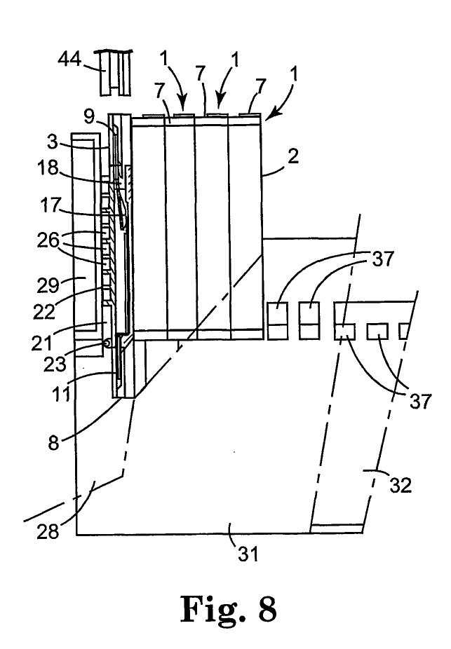

As may be specifically seen in FIGS. 5 and 8, the rail having a U-shaped cross section forming the support frame 28 can have an unsymmetrical shape with one of the side arms 31 having a greater length than the other side arm 32. This means that the slot 34 on one side of the terminal strip can be deeper than the slot 34 on the other side of the terminal strip. Having slots of different depths improves the mechanical stability of the terminal strip 1.

If, for example, 32 terminal strips are fitted onto a rail 28 having a given length, other means intended to fasten the terminal strips together have been provided. These means are in the form of dovetail-shaped tenons 39 (FIG. 3) protruding a few millimeters over the height of the lateral face 3 on which the lead-in channels 26 are provided. These tenons 39 mate with mortices 41 in the form of grooves running over the entire height of the terminal strip from the side having the lateral face 2 with the flat plate 27. This really allows the terminal strips to be bonded together, to place the maximum number of them on a rail 28, to efficiently close off the lead-in channels 26 with the flat plate 27 of the directly juxtaposed terminal strip and to provide excellent mutual mechanical cohesion of the terminal strips.

In order to improve the screening of the connections, a drain collector has been provided in the form of a metal tongue 42 (FIG. 6) which will bear on an insulating upright 43 of the body of the terminal strip. This allows the drain wires to be gathered together to provide their earth connection through the support frame 28.

Provision has also been made for the possible insertion into the upper insulation-displacement contacts 9 of a plug 44 of a jumper (FIG. 8) making it possible to make a cross-connection within a telephone, computer or other distribution frame.

To be able to recognize the various terminal strips among themselves, a label holder 46 has been provided on the upper longitudinal side 7. This label holder 46 is used either to slide on individual labels for each of the terminal strips or to slide on only a single long label, when all the terminal strips are closely juxtaposed alongside one another.

The present invention is not limited to the embodiment described and illustrated. Many modifications may be made without thereby departing from the context defined by the scope of the set of claims.

1. A terminal strip for interconnecting electrical lines, especially telephone or computer lines, characterized in that it comprises:
a) a single row of mutually parallel first conducting elements (9) placed side-by-side, each first conducting element having an insulation-displacement end configured to receive a line wire, that is oriented towards an upper longitudinal side (7) of the terminal strip, and a single row of mutually parallel, second conducting elements (11) placed side-by-side, each having an insulation-displacement end configured to receive a line wire, that is oriented towards a lower longitudinal side (8) of the terminal strip;
b) the insulation-displacement end of the first (9) and second (11) conducting elements all lie within a same plane (P);
c) first and second two-part conducting elements, wherein each first conducting element (9) is separated from a second conducting element by a point of interruption; and
d) said point of interruption is offset with respect to a plane defined by the first and second conducting elements.

2. A terminal strip according to claim 1, characterized in that the first conducting element (9) comprises at least one moveable flexible tab (14) which is positioned on a fixed part (16) of the second conducting element (11).

3. A terminal strip according to claim 2, characterized in that the upper longitudinal side (7) of the terminal includes a plurality of access holes (18) adjacent to each first conducting element (9), for the insertion of a conducting test plug (19) or an insulating interrupt plug, which will be inserted through an access hole (18) into the body of the terminal strip and adjacent to the point of interruption (17) between the moveable flexible tab (14) and the fixed part (16).

4. A terminal strip according to one of the preceding claims, characterized in that the upper (7) and lower (8) longitudinal sides have a push-in slot (13) for each insulation-displacement end, the push-in slots (13) extend transversely from the upper (7) or lower (8) longitudinal sides and extend into the terminal block along one of the lateral faces (3).

5. A terminal strip according to claim 4, further characterized in that it includes two lateral faces (3), lead-in channels (26) molded or formed in, or attached to one of the lateral faces (3) of the terminal block, which are located on the same lateral face of the terminal block as the push-in slots (13), each of the channels (26) curving away from one of the transverse sides (4) in the direction of at least one of the push-in slots (13).

6. A terminal strip according to claim 4, characterized in that it includes interlocking means (39, 41), located on each of the two lateral faces such that the interlocking means (39) on one face (3) fits into the interlocking means (41) on the other face (2).

7. A terminal strip according to claim 6, characterized in that it includes a drain collector (42) near the upper longitudinal side (7).

8. A terminal strip according to claim 5 further including a rail forming support frame, characterized in that it includes a label holder (29), or a plate, which will close off the lead-in channels (26) of the last terminal strip positioned on the rail forming the support frame (28), and a label holder (46) located on the upper longitudinal side (7).
